(19) United States
(12) Patent Application Publication
(10) Pub. No.: US 2010/0185328 A1
(43) Pub. Date: Jul. 22, 2010

(54) Robot and control method thereof

(75) Inventors: Hong Won Kim, Seoul (KR); Woo Sup Han, Yongin-si (KR); Yong Jae Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/656,023

(22) Filed: Jan. 13, 2010

(30) Foreign Application Priority Data
Jan. 22, 2009 (KR) 10-2009-5537

(51) Int. Cl. G05B 15/00

(52) U.S. Cl. 700/259; 700/264

(57) ABSTRACT

Disclosed herein are a robot that supplies a projector service according to a user's context and a controlling method thereof. The robot includes a user detection unit detecting a user; a user recognition unit recognizing the user; an object recognition unit recognizing an object near the user; a position perception unit perceiving relative positions of the object and the user; a context awareness unit perceiving the user's context based on information on the user, the object and the relative positions between the user and the object; and a projector supplying a projector service corresponding to the user's context.

### CROSS-REFERENCE TO RELATED APPLICATIONS

This application claims the benefit of Korean Patent Application No. 2009-0005537, filed on Jan. 22, 2009 in the Korean Intellectual Property Office, the disclosure of which is incorporated herein by reference.

### BACKGROUND

1. Field

The embodiments relate to a robot and a controlling method thereof, and more particularly, to a robot that supplies a projector service according to a user's context and a controlling method thereof.

2. Description of the Related Art

Unlike other existing information apparatuses, a robot is distinctive in terms of having a driving device for traveling thereof, and an operative device such as a robot arm to lift an object and a mechanical structure to control an angle of a built-in camera. Those operational devices have been developed from technology used in industrial and military robots.

Such industrial and military robots use preset programs and thus have difficulty interacting with a user after being started. On the other hand, a service robot specifically designed to service human beings has been designed to intelligently cope with the user's various demands and to interact with the user. In addition, as the service robots have recently been equipped with various functions almost equivalent to those of computers, an interaction system similar to a graphic user interface (GUI) supplied by computer software becomes necessary. To this end, diverse user interface devices have been designed and mounted to the service robot.

### SUMMARY

Therefore, it is an aspect of the present invention to provide a robot supplying a projector service corresponding to a user's context through context awareness with respect to information on the user and objects around the user, and a controlling method thereof.

Additional aspects and/or advantages of the invention will be set forth in part in the description which follows and, in part, will be apparent from the description, or may be learned by practice of the invention.

The foregoing and/or other aspects of the present invention are achieved by providing a method to control a robot, including detecting and recognizing a user; recognizing an object; perceiving relative positions between the user and the object; perceiving a context of the user according to the recognizing of the user, the object and the relative positions; and supplying a projector service corresponding to the context of the user.

The user detection and recognition may include detecting the user's face area; extracting unique features of the face; and comparing the user's face with a reference image prestored in a database.

The object detection may include finding a specific object from information on an image around the user; and determining whether the specific object is registered in advance in the database. The relative position perception perceives the relative positions between the user and the object using a stereo vision technology. The user context perception performs context awareness that predicts and supplies the user's demanded service based on the context of the user, the object and the positions.

The robot control method may further include inquiring whether the user wants the projector service corresponding to the user's context. The robot control method may further include checking whether a service closing condition is satisfied during the projector service. When the service closing condition is satisfied, the service is stopped.

The projector service supplying includes supplying an interactive service between the user and projection contents being projected by a projector, through a human-robot interface (HRI).

The foregoing and/or other aspects of the present invention are achieved by providing a robot including a user detection unit detecting a user; a user recognition unit recognizing the user; an object recognition unit recognizing an object; a position perception unit perceiving relative positions of the object and the user; a context awareness unit perceiving a context of the user based on information on the user, the object and the relative positions between the user and the object; and a projector supplying a projector service corresponding to the context of the user.

The user detection unit may detect a face area from the user's images being continuously input in real time through a closed-circuit television (CCTV), a CCD camera, a PC camera or an IR camera.

The user recognition unit may normalize an image of the user's face detected by the user detection unit, extracts unique features of the face, and compares the user's face image with a reference image prestored in a database.

The object recognition unit may find a specific object in image information and identifies the specific object using data prestored in the database, thereby recognizing the object. The position perception unit may perceive relative positions between the object and the user using a stereo vision technology. The context awareness unit may collect the context through information on the user, the object and the positions, thereby predicting operations to be actually performed.

The robot may further include an image recognition unit obtaining images of the user and the object. The robot may further include a speaker outputting sound to the user; and a microphone for the user to input a command to the robot. The robot may further include a service unit supplying an interactive service between the user and projection contents being projected by the projector, through HRI.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic block diagram of software and hardware of a robot according to an embodiment;

FIG. 2A and FIG. 2B are example views illustrating the data structure of context information of the robot of FIG. 1;

FIGS. 3A to 3C are views illustrating a projector service supplied by the robot of FIG. 1; and

FIG. 4 is a control flowchart of the robot according to the embodiment.

### DETAILED DESCRIPTION

Reference will now be made in detail to the embodiments of the present invention, examples of which are illustrated in the accompanying drawings, wherein like reference numerals refer to the like elements throughout. The embodiments are described below to explain the present invention by referring to the figures.

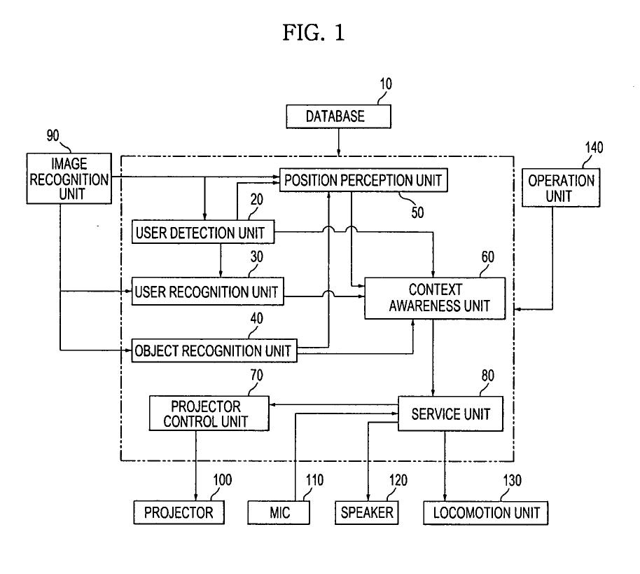

FIG. 1 is a schematic block diagram of software and hardware of a robot according to an embodiment of the present invention.

As shown in FIG. 1, the software of the robot includes a database 10 storing a user list and service data, a user detection unit 20 detecting a user, a user recognition unit 30 recognizing the detected user, an object recognition unit 40 recognizing an object, a position perception unit 50 perceiving the positions of the object and the user, a context awareness unit 60 inferring the context of the object and the user based on certain rules according to information on the object and the user, a projector control unit 70 controlling a projector 100, and a service unit 80 performing different services according to content context.

The database 10 stores the user list and service data. More specifically, an image of a user's face, 2D and 3D models of a certain object, and various services to be performed according to the result of context awareness, and services such as a drawing imitation game, are prestored in the database 10.

The user detection unit 20 detects a person's face or body upon input of an image from an image recognition unit 90. More particularly, the user detection unit 20 detects a face area from user's images being continuously inputted in real time through a closed-circuit television (CCTV), a CCD camera, a PC camera or an IR camera.

Although there are several conventional methods to detect the face area from the input images, the user detection unit 20 of the embodiment of the present invention uses a cascaded face classifier applying Adaptive Boost Learning Filter (AdaBoost) algorithm. According to one of the conventional face detection methods, which requires a movement of an object for the detection, the user should make a movement. According to another conventional method which abstracts a skin-color area using color information, a color camera is used and the operation is subject to variation of light and the user's race and skin color.

The cascaded face classifier using the AdaBoost algorithm is developed to solve such conventional problems.

According to the cascaded face classifier algorithm using the AdaBoost algorithm, when variations of classes are so great, a complex decision boundary is required for classification of the classes. The AdaBoost algorithm is a classifier learning algorithm appropriate for such a case, which generates a high-performance strong classifier by combining a plurality of weak classifiers. Thus, the cascaded face classifier algorithm using the AdaBoost algorithm is adequate for learning of a classifier to detect a face.

Furthermore, the cascaded face classifier algorithm using the AdaBoost algorithm, which does not necessitate information on movement or color, is capable of detecting the face at a high speed without restriction of users even in a black-and-white camera.

The user recognition unit 30 recognizes the detected user. More specifically, the user recognition unit 30 normalizes an image of the user's face detected by the user detection unit 20, extracts unique features of the face, and compares the user's face image with a reference image prestored in the database 10. A face includes about 200˜300 effective features for recognition. In order to extract features influenced by light and countenance from the effective features, learning processes of a face recognition module are performed with respect to a large-scale database. A principle component analysis (PCA) is mostly used in processes of ‘feature extraction’, which refers to conversion from an image space to a feature space. There are also linear discriminant analysis (LDA), independent component analysis (ICA) and so on applying the PCA.

The user (person) detecting and recognizing method is already disclosed in greater detail in KR Patent No. 0455295.

Upon input of the image from the image recognition unit 90, the object recognition unit 40 detects and recognizes an object in the input image. That is, the object recognition unit 40 finds a specific object in image information obtained by the image recognition unit 90 and identifies the specific object using information prestored in the database 10. Here, the finding is referred to as “detection” and the identifying is referred to as “recognition.” According to this embodiment, the object recognition unit 40 performs both the detection and the recognition.

Also, the object recognition unit 40 matches an image signal to the 2D+3D model stored in the database 10, extracts an object ID variable for recognition of the specific object and an object position variable, and outputs the variables as object recognizing signals.

To be more specific, an object model generation unit (not shown) inputs image signals for the specific object, thereby extracting local structure segments of particular corner points of the specific object, generates object models corresponding to the respective extracted local structure segments, and supplies the 2D+3D model to the database 10. The database 10 classifies the object models generated from the object model generation unit (not shown) into the 2D model and the 3D model, and stores the 2D model and the 3D model as linked to each other. Thus, the object recognition unit 40 recognizes the specific object by matching the image signals input from the image recognition unit 90 and the 2D and 3D models stored in the database 10 through the above processes. The object recognition technology is generally known, as disclosed in detail in KR Patent No. 0606615.

The position perception unit 50 perceives relative positions of the object and the user using a stereo vision technology, that is, finds out depth information from images obtained using two or more cameras. Using the depth information and robot position information, the position perception unit 50 can perceive positions of the robot, object or user. More particularly, the position perception unit 50 includes an input image pre-processing unit (not shown), a stereo matching unit (not shown), and an image post-processing unit (not shown). In order that the stereo matching unit may more easily perform stereo matching with the images input from the image recognition unit, that is, two cameras installed on the left and the right, the input image pre-processing unit performs corresponding image processing techniques, thereby improving the overall performance. Here, the image processing techniques performed by the input image pre-processing unit include calibration, scale down filtering, rectification, brightness control and so forth. In addition, the input image pre-processing unit removes noise existing in the image information and, if the images input from the two cameras have different brightness or contrast levels, standardizes the image information so that the image signals from the two cameras are under the same state.

The stereo matching unit performs stereo matching with the left and right images calibrated at the input image pre-processing unit, thereby calculating a disparity map, and accordingly composes one image.

The image post-processing unit calculates and extracts depth based on the disparity map calculated by the stereo matching unit, thereby producing a depth map. Here, the image post-processing unit performs segmentation and labeling with respect to respectively different objects in the depth map. That is, information on horizontal and vertical extents of the respective objects and distances from the robot to the objects are measured and output.

The context awareness unit 60 learns various information related to the user and the object and the depth information, and collects a context, thereby predicting operations to be actually performed. Here, the context refers to information featuring the state of the object, and the object may be a person, a place or another physical object. The context awareness refers to an operation of supplying relevant information or service to the user, based on the context. In this embodiment, the context may be determined by the user information, the object information and the depth information. The context awareness unit 60 transmits the information to the service unit 80 so that the user's demanded service is predicted based on the context and supplied.

More particularly, the context awareness unit 60 may include a user context unit (not shown), an application context unit (not shown), a circumstantial context unit (not shown) and a robot context unit (not shown), to collect and control the context. The user context unit may be recorded with the user list and matters regarding preference for application. The application context unit and the robot context unit are recorded with controlling commands and states externally disclosed. The circumstantial context unit is recorded with detailed information on the robot and an image and sound output device capable of application. According to this, the context awareness unit 60 selects a proper interpret table among registered interpret tables in a registered application state, and the service unit 80 accordingly generates a command. The detailed information can be added as necessary, for example, using an XML method wherein the form and the content are separated.

The projector control unit 70 selects a projector direction and projection content by the command generated by the service unit 80 in accordance with the application registered in the context awareness unit 60.

The service unit 80 generates the command in accordance with the selected interpret table when it becomes the application state registered in the context awareness unit 60. Before generating the command, the service unit 80 confirms the user's intention through a speaker 120. More particularly, before the robot supplies a service according to the context awareness module, the service unit 80 confirms the user's intention and, if the user inputs an affirmative message through a microphone 110, supplies the service.

The hardware of the robot according to the embodiment of the present invention includes the image recognition unit 90 input with circumstantial information of the robot, the projector 100 providing a projector function, the microphone 110 input with a command from the user, the speaker 120 transmitting the robot's intention to the user, a locomotion unit 130 enabling locomotion of the robot, and an operation unit 140 performing the above various operations.

The image recognition unit 90 may be a CCTV, a CCD camera, a PC camera or an IR camera, and may be provided in a pair, that is, on the left and the right of the robot's sight to perceive relative positions of the object and the user using stereo vision technology.

The projector 100 is a type of an optical apparatus that projects enlarged photos, pictures, letters and the like printed on a slide film or transparent film to a screen through a lens so that the projection contents can be shown to many people at one time. According to this embodiment, balloon images or a story book script can also be projected to correspond a certain object.

The microphone 110 transmits sound generated outside of the robot to the robot. The speaker 120 outputs sound or sound effects corresponding to various services to convey specific intentions to the user.

The locomotion unit 130 enables locomotion of the robot, for example, being in the form of wheels or human-like legs. The operation unit 140 performing the various operations of the software may include a CPU or an additional unit of the CPU.

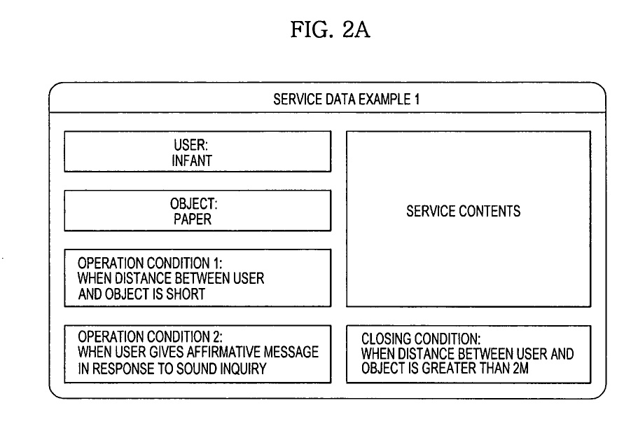

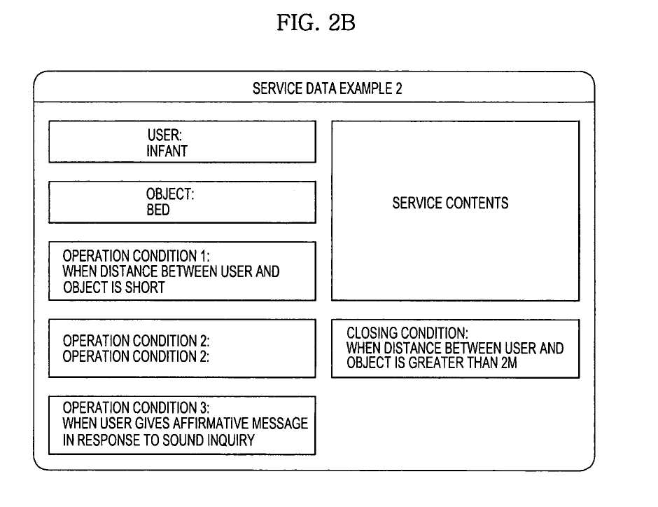

FIG. 2A and FIG. 2B are example views illustrating the data structure of context information of the robot.

As shown in FIG. 2A, the database 10 of the robot stores the information on the user and the object, the depth information, and contents of specific services according to the user's command. Therefore, when the user is recognized as an infant registered in advance in the database 10 and the object detected from the image around the user is recognized as a paper, relative positions between the object (paper) and the user (infant) are perceived. When the distance between the user and the object is determined to be short, the robot inquires of the user whether the user wants a service stored in the database 10, such as a drawing imitation game, by outputting the inquiry through the speaker 120 according to the context awareness. When the user inputs an affirmative message through the microphone 110, the service unit 80 supplies the user with the service contents stored in the database 10. If a closing condition is satisfied, for example, when the distance between the user and the object is greater than 2 m, the service unit 80 stops the service.

As shown in FIG. 2B, if it is determined that the user is an infant and the object around the user is a bed, relative positions between the object (bed) and the user (infant) are perceived. When it is determined to be dark according to the context awareness, the robot inquires of the user whether the user wants a service stored in the database 10, such as a storybook reading, by outputting the inquiry through the speaker 120. Next, when the user inputs an affirmative message through the microphone 110, the service unit 80 supplies the user with the service contents stored in the database 10. In addition, if a closing condition is satisfied, for example, when the distance between the user and the object is greater than 2 m or when a predetermined time passes, the service unit 80 stops the service.

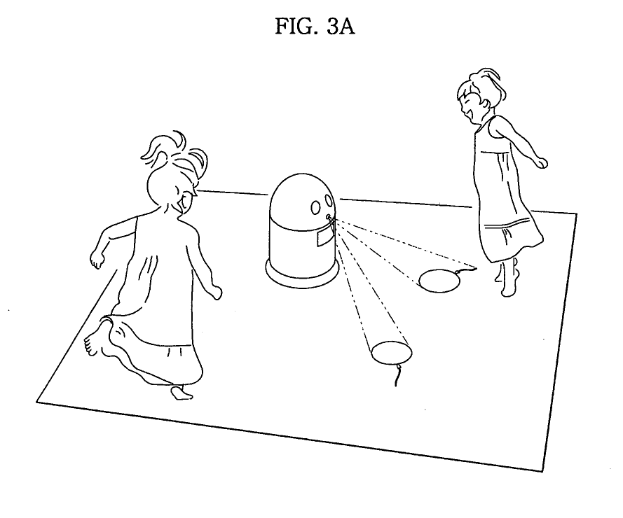

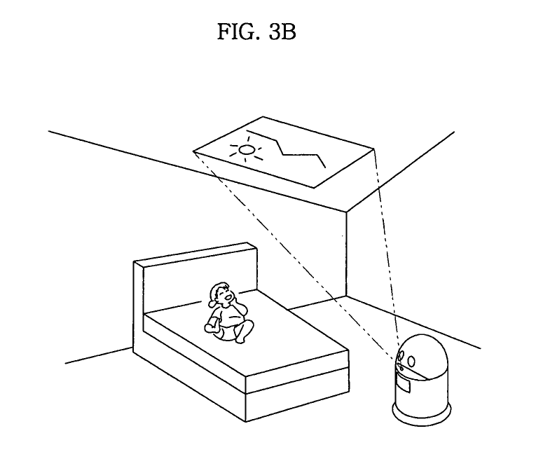

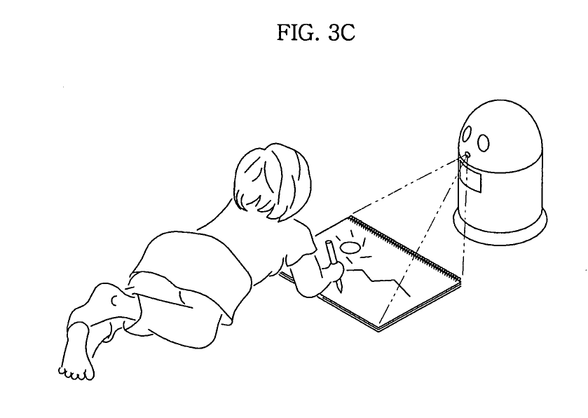

FIG. 3A to FIG. 3C are views illustrating a projector service supplied by the robot.

As shown in FIG. 3A, when the user is detected by the user detection unit 20 and recognized by the user recognition unit 30 to be an infant, and when the object is detected by the object recognition unit 40 to be a mat, the position perception unit 50 perceives relative positions between the object (mat) and the user (infant) using the stereo vision technology. When the distance between the user and the object is determined to be short, the robot inquires of the user whether the user wants a service such as a balloon bursting game, according to the context awareness. When the user inputs an affirmative message through the microphone 110, the service unit 80 projects balloon images onto the mat using the projector 100 to supply the “balloon bursting game” service stored in the database 10. When the user touches the balloon image, a bursting balloon image may be projected along with sound effects output through the speaker 120.

As shown in FIG. 3B, in addition, when the user is detected and recognized to be an infant by the user detection unit 20 and the user recognition unit 30, and when the object is detected to be a bed by the object recognition unit 40, the position perception unit 50 perceives relative positions between the object (bed) and the user (infant) using the stereo vision technology. When it is determined that the distance between the user and the object is short and it is dark, the robot inquires of the user whether the user wants a service such as a storybook reading, according to the context awareness. When the user inputs an affirmative message through the microphone 110, the service unit 80 projects a storybook image onto the ceiling to supply the “storybook reading” service stored in the database 10. Also, the storybook script may be output by a text-to-speech (TTS) technology.

Also, as shown in FIG. 3C, when the user is detected and recognized to be an infant by the user detection unit 20 and the user recognition unit 30, and when the object is detected to be a paper by the object recognition unit 40, the position perception unit 50 perceives relative positions between the object (paper) and the user (infant) using the stereo vision technology. When it is determined that the distance between the user and the object is short, the robot inquires of the user whether the user wants a service such as a drawing imitation game, according to the context awareness. When the user inputs an affirmative message through the microphone 110, the service unit 80 may project a draft image on the paper to supply the user with the “drawing imitation game” service. If the user successfully draws after the draft image, a color painting service may be further supplied.

It is noted that such services supplied to the user according to the context awareness are determined by complex factors including the user information, the object information, the depth information and the circumstances, and those factors can be altered in various forms by a database designer.

As explained above, the service unit 80 of the robot is capable of supplying an interactive service between the user and the projection contents using a human-robot interface (HRI). For example, balloons are burst upon overlap between the user and the balloon images in the “balloon bursting game.”

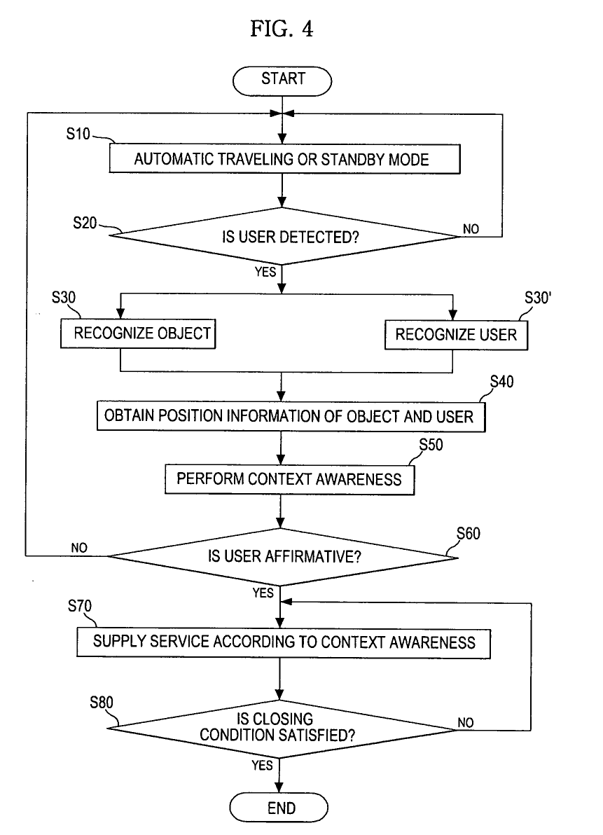

FIG. 4 is a control flowchart of the robot according to the embodiment of the present invention.

Referring to FIG. 4, the robot detects a user at a normal time while automatically traveling or in a standby mode. That is, the user detection unit 20 detects a person's face or body upon input of an image from the image recognition unit 90. More particularly, the user detection unit 20 detects the face area from images being continuously input in real time from a CCTV, a CCD camera, a PC camera or an IR camera equipped with a light. To detect the face area from an input image, the user detection unit 20 of this embodiment uses the cascaded face classifier applying the AdaBoost algorithm, as opposed to various conventional face area detection methods (operations S10 and S20).

Next, the user recognition unit 30 recognizes the user and the object recognition unit 40 recognizes the object around the user. To be more specific, the user recognition unit 30 normalizes the user's face image detected by the user detection unit 20, extracts unique features of the face, and compares the user's face image with the reference image prestored in the database 10. A face generally includes about 200˜300 effective recognizable features. In order to extract features influenced by light and countenance from the effective features, learning processes of the face recognition module are performed with respect to a large-scale database. The PCA is mostly used for the feature extraction which refers to conversion from an image space to a feature space. There are also LDA, ICA and so on applying the PCA. Upon input of the image from the image recognition unit 90, the object recognition unit 40 detects and recognizes an object in the input image. That is, the object recognition unit 40 finds a specific object in image information obtained by the image recognition unit 90 and identifies the specific object using prestored data. Here, the finding is referred to as “detection” and the identifying is referred to as “recognition.” According to this embodiment, the object recognition unit 40 performs both the detection and the recognition (operations S30 and S30′).

Next, the position perception unit 50 obtains the distance information regarding the user and the object recognized through the above processes. More specifically, the position perception unit 50 perceives relative positions of the object, for example a paper, and the user, for example an infant, using a stereo vision technology, that is, finds out depth information from images obtained using two or more cameras. Using the depth information and robot position information, the position perception unit 50 can perceive positions of the robot, object or user (operation S40).

Next, the context awareness unit 60 learns various information related to the user and the object and the depth information, and collects the context, thereby predicting operations to be actually performed. Here, the context refers to information featuring the state of the object, and the object may be a person, a place or another physical object. The context awareness refers to an operation of supplying relevant information or service to the user, based on the context. In this embodiment, the context may be determined by the user information, the object information and the depth information. The context awareness unit 60 transmits the information to the service unit 80 so that the user's demanded service is predicted based on the context and supplied (operation S50).

The robot inquires the user's intention through the speaker. In other words, the robot inquires of the user whether the user wants to be supplied with a service, based on the context recognized by the context awareness unit 60 (operation S60).

Next, when the user gives an affirmative message, the service unit 80 supplies the service in accordance with the context awareness. According to this embodiment, projector services which utilize the projector 100, such as “drawing imitation game,” “storybook reading” or “balloon bursting game,” may be supplied (operation S70).

As described above, the service unit 80 may supply an interactive service (drawing imitation game) between the user and the projection contents using a human-robot interface (HRI), or a non-interactive service (storybook reading).

Next, while the projector service is being supplied by the service unit 80 to the user, the context awareness unit 60 determines whether the closing condition is satisfied, for example, whether the distance between the user and the object is greater than 2 m or whether a predetermined time passes. If the condition is satisfied, the service is stopped (operation S80).

On the other hand, if the user gives a negative message in operation S60, the robot automatically travels back or returns to the standby mode.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. A method to control a robot, comprising:
detecting and recognizing a user;
recognizing an object;
perceiving relative positions between the user and the object;
perceiving a context of the user according to the recognizing of the user, the object and the relative positions; and
supplying a projector service corresponding to the context of the user.

2. The robot control method according to claim 1, wherein the detecting and recognizing the user comprises:
detecting an area of the user's face;
extracting unique features of the face; and
comparing the user's face with a reference image prestored in a database.

3. The robot control method according to claim 1, wherein the recognizing the object comprises:
finding a specific object from information on an image; and
determining whether the specific object is registered in advance in the database.

4. The robot control method according to claim 1, wherein the perceiving the relative positions comprises using a stereo vision technology.

5. The robot control method according to claim 1, wherein the perceiving the context of the user comprises predicting and supplying a service demanded by the user based on the context of the user, the object and the relative positions.

6. The robot control method according to claim 1, further comprising:
asking the user whether the user wants the projector service corresponding to the context of the user.

7. The robot control method according to claim 1, further comprising: determining if a service closing condition is satisfied during the projector service.

8. The robot control method according to claim 7, further comprising: stopping the service when the service closing condition is determined.

9. The robot control method according to claim 1, wherein the projector service supplying comprises supplying an interactive service between the user and projection content being projected by a projector, through a human-robot interface (HRI).

10. A robot comprising:
a user detection unit detecting a user;
a user recognition unit recognizing the user;
an object recognition unit recognizing an object;
a position perception unit perceiving relative positions of the object and the user;
a context awareness unit perceiving a context of the user based on information on the user, the object and the relative positions between the user and the object; and
a projector supplying a projector service corresponding to the context of the user.

11. The robot according to claim 10, wherein the user detection unit detects a face area from the images of the user being continuously input in real time through a closed-circuit television (CCTV), a CCD camera, a PC camera or an IR camera.

12. The robot according to claim 11, wherein the user recognition unit normalizes an image of the detected face, extracts unique features of the face, and compares the user's face image with a reference image prestored in a database.

13. The robot according to claim 10, wherein the object recognition unit finds a specific object in image information and identifies the specific object using data prestored in a database, thereby recognizing the object.

14. The robot according to claim 10, wherein the position perception unit perceives relative positions between the object and the user using a stereo vision technology.

15. The robot according to claim 10, wherein the context awareness unit collects the context through information on the user, the object and the positions, thereby predicting operations to be actually performed.

16. The robot according to claim 10, further comprising an image recognition unit obtaining images of the user and the object.

17. The robot according to claim 10, further comprising:
a speaker outputting sound to the user; and
a microphone for the user to input a command to the robot.

18. The robot according to claim 10, further comprising:
a service unit supplying an interactive service between the user and projection contents being projected by the projector, through HRI.
